(19) United States
(12) Patent Application Publication
(10) Pub. No.: US 2026/0189392 A1
(43) Pub. Date: Jul. 2, 2026

(54) SYSTEM AND METHOD FOR CRYPTOGRAPHICALLY SOVEREIGN, HARDWARE-ROOTED IDENTITY AND EXECUTION AUTHORITY FOR AUTONOMOUS AI AGENTS

(71) Applicant: George William Bickerstaff, III, Greenwich, CT (US)

(72) Inventor: George William Bickerstaff, III, Greenwich, CT (US)

(21) Appl. No.: 19/540,654

(22) Filed: Feb. 14, 2026

(51) Int. Cl. H04L 9/32; H04L 9/08

(52) U.S. Cl. CPC H04L 9/3213; H04L 9/0877; H04L 9/3247

(57) ABSTRACT

A system and method provide cryptographically sovereign, hardware-rooted identity and execution authority for autonomous AI agents. Each agent is assigned a permanent Sovereign Agent Identity Token (SAIT) that is physically bound at manufacture or first boot to a hardware security module on the host device. The SAIT carries an immutable genesis block containing the agent's model lineage, training data hashes, owner chain, and current compliance state. No agent may initialize, generate plans, or issue actuation commands unless a valid, live SAIT is presented and attested by the hardware. Remote revocation or suspension of the SAIT instantly renders the agent inoperable across all instances. The system includes deterministic execution gating, swarm propagation of revocation signals, and immutable provenance logging. The invention establishes the root of trust for agent existence and action, transforming digital governance into physical, non-bypassable control.

### CPC CLASSIFICATIONS

H04L 9/32 Cryptographic mechanisms for authentication and verification
G06F 21/44 Program or device authentication
G06F 21/57 Certifying or maintaining trusted computer platforms
G06F 21/62 Protecting access to data via a platform
G06N 20/00 Machine learning

### FIELD OF THE INVENTION

The invention relates to cryptographic identity management, trusted execution environments, and hardware-enforced execution control for autonomous artificial intelligence agents, particularly agents operating on edge hardware in regulated, safety-critical, or sovereign environments.

### BACKGROUND OF THE INVENTION

Autonomous AI agents are now routinely deployed on local and edge devices where they can initiate physical actions without continuous cloud oversight.

Existing approaches rely on software-based credentials, cloud authentication, or application-level permissions. These systems are vulnerable to spoofing, cloning, delayed revocation, and lack any hardware-rooted binding between the agent's identity and the physical device on which it runs.

No prior system provides a permanent, hardware-bound, cryptographically sovereign identity that serves as both the immutable birth certificate and the ongoing, non-bypassable execution authority for an AI agent. This gap creates unacceptable risk in regulated domains where agent actions can cause physical harm, regulatory violations, or massive liability.

### SUMMARY OF THE INVENTION

The present invention solves the above problems by providing a cryptographically sovereign, hardware-rooted identity and execution authority system for autonomous AI agents.

Baseline Embodiment—At manufacture or first boot, a Sovereign Agent Identity Token (SAIT) is generated and irreversibly bound inside a hardware security module on the device. The SAIT includes a genesis block containing model lineage, training data hashes, owner chain, and initial compliance state. All agent actions are gated by a non-bypassable execution control mechanism that requires a valid, live SAIT.

Advanced Embodiment—The system further enables instant remote revocation, swarm-wide propagation of revocation signals, dynamic policy injection, cryptographic attestation to external verifiers, and immutable provenance logging of every lifecycle event. Revocation of the SAIT instantly renders the agent inoperable across all instances.

The invention delivers unexpected technical advantages: it transforms digital governance into physical, non-bypassable control; it provides regulators, insurers, and owners with instantaneous, hardware-enforced revocation; and it creates an auditable, litigation-ready chain of custody for every agent action.

### DEFINITIONS

Agent Provenance Chain—The immutable, append-only cryptographic record of every lifecycle event (creation, updates, revocations, actions, audits) bound to the SAIT.

Cryptographic Attestation—A signed statement generated inside the hardware security module that proves to external verifiers the identity, integrity, and compliance state of an agent.

Deterministic Execution Gate—A non-bypassable hardware-enforced control point that blocks all agent actions unless a live SAIT is verified.

Execution Authority—The right of an agent to initialize, plan, or actuate, granted only when a valid, attested SAIT is presented to the hardware gate.

Genesis Block—The immutable initial record created inside the hardware security module containing the agent's model lineage, training data hashes, owner chain, and initial compliance state.

Hardware-Rooted Binding—The irreversible cryptographic and physical association of the SAIT to a specific device's hardware security module at manufacture or first boot.

Revocation Signal—A cryptographically signed command that instantly invalidates a SAIT and renders the associated agent inoperable.

Sovereign Agent Identity Token (SAIT)—A cryptographically signed, hardware-bound digital identity that serves as the permanent root of trust and execution authority for an autonomous AI agent.

Swarm Propagation Protocol—The mechanism by which revocation or compliance signals from one agent are automatically and securely propagated to peer agents in the same swarm.

Trusted Execution Environment (TEE)—A hardware-isolated secure enclave that protects code and data from the host operating system, hypervisor, and all other software.

### DISTINCTION FROM PRIOR ART

Trusted computing platforms provide hardware-rooted device identity but do not bind identity to AI model lineage and training data provenance. Blockchain-based identity systems lack hardware binding and cannot enforce physical execution control. Traditional software licensing protects intellectual property but offers no physical safety guarantees and can be bypassed. The present invention applies trusted hardware in a novel manner specifically designed for autonomous agent governance.

### Detailed Implementation Embodiments

### Example 1—Automotive Deployment

In a preferred automotive embodiment, the SAIT is generated during vehicle manufacturing and bound to the vehicle's central compute module equipped with a hardware security module. The genesis block includes the VIN cryptographic hash, autonomous driving model version, training dataset Merkle root, manufacturer identity, and current insurance policy attestation. The execution control mechanism intercepts all drive-by-wire commands. Before any maneuver, the system validates the SAIT, confirms active insurance coverage, and verifies the vehicle is within approved jurisdictions. Upon any accident, the provenance ledger automatically freezes and transmits a cryptographically sealed forensic package to authorities.

### Example 2—Medical Robotics Deployment

In a surgical robotics embodiment, the SAIT is bound to the control computer of a da Vinci-type system equipped with a hardware security module. The genesis block includes the device serial number, FDA 510(k) clearance code, surgical AI model checksum, hospital ownership certificate, and biometric templates of authorized surgeons. The execution control mechanism requires both a valid SAIT and real-time biometric authentication of the operating surgeon. All actions are logged with operator identity, exact instrument position, and force readings. Patient consent and malpractice insurance status are cryptographically verified before every procedure.

### BRIEF DESCRIPTION OF THE DRAWINGS

FIG. 1 SYSTEM ARCHITECTURE

FIG. 2 SAIT GENERATION AND BINDING

FIG. 3 EXECUTION AUTHORITY GATE

FIG. 4 REMOTE REVOCATION AND PROPAGATION

FIG. 5 PROVENANCE LOGGING AND ATTESTATION

DETAILED DESCRIPTION OF THE DRAWINGS

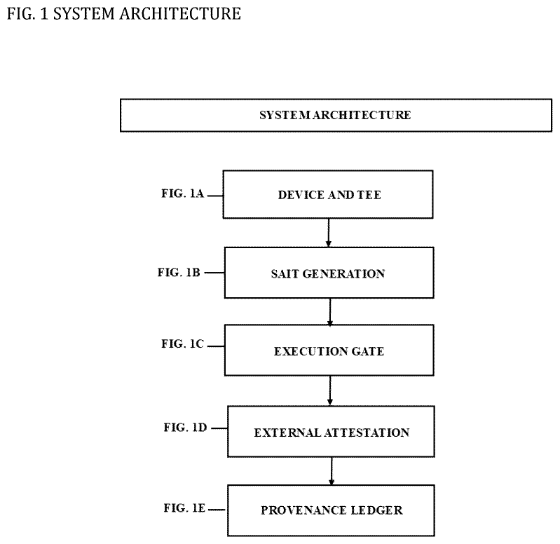

### FIG. 1 System Architecture

FIG. 1 illustrates the complete system architecture.

FIG. 1A DEVICE AND TEE shows a physical edge device such as a robot, vehicle, medical instrument, or appliance. This device contains a hardware security module that is fully protected from the host operating system and all application software. The module serves as the secure foundation where the Sovereign Agent Identity Token is created and stored.
FIG. 1B SAIT GENERATION shows the first-boot or manufacturing process that creates the Sovereign Agent Identity Token inside the hardware security module. The token is generated with a unique genesis block containing all initial identity data. This process ensures the token is permanently bound to the specific hardware device.
FIG. 1C EXECUTION GATE shows the non-bypassable hardware gate positioned between the agent's reasoning engine and all actuation or output pathways. The gate opens only after successful SAIT verification. This prevents any unauthorized agent action from reaching the physical hardware.
FIG. 1D EXTERNAL ATTESTATION shows secure communication channels between the hardware security module and external parties including regulators, owners, insurers, and verifiers. These channels allow the generation of cryptographically verifiable proofs. The attestations confirm the agent's identity and compliance state without exposing sensitive data.
FIG. 1E PROVENANCE LEDGER shows the immutable, append-only ledger that records every lifecycle event in cryptographically signed blocks. The ledger maintains a complete history of the agent from creation to revocation. This provides regulators and courts with tamper-proof evidence for any future review.

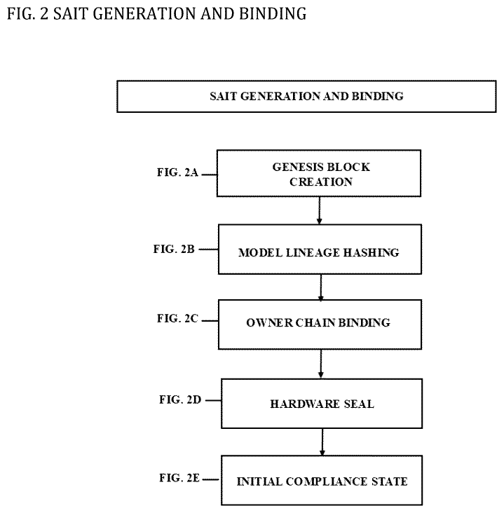

### FIG. 2 SAIT Generation and Binding

FIG. 2 illustrates the creation and permanent binding of the Sovereign Agent Identity Token.

FIG. 2A GENESIS BLOCK CREATION shows the generation of the immutable genesis block inside the hardware security module at first boot. The block captures the agent's model lineage and training data hashes. This establishes the permanent root identity that cannot be altered later.
FIG. 2B MODEL LINEAGE HASHING shows cryptographic hashing of the agent's model architecture, weights, and training data. These hashes are stored inside the genesis block. The process ensures any future change to the model can be instantly detected.
FIG. 2C OWNER CHAIN BINDING shows the binding of the initial owner and any subsequent authorized transfer chain to the SAIT. Each ownership change is recorded with cryptographic signatures. This creates a verifiable chain of custody for the entire life of the agent.
FIG. 2D HARDWARE SEAL shows the one-way cryptographic and physical binding of the SAIT to the specific device hardware. The binding is irreversible once completed. This prevents the token from ever being moved to another device.
FIG. 2E INITIAL COMPLIANCE STATE shows the recording of the agent's starting regulatory, safety, and policy compliance state at creation. The state is cryptographically signed inside the hardware security module. This initial state serves as the baseline for all future compliance checks.

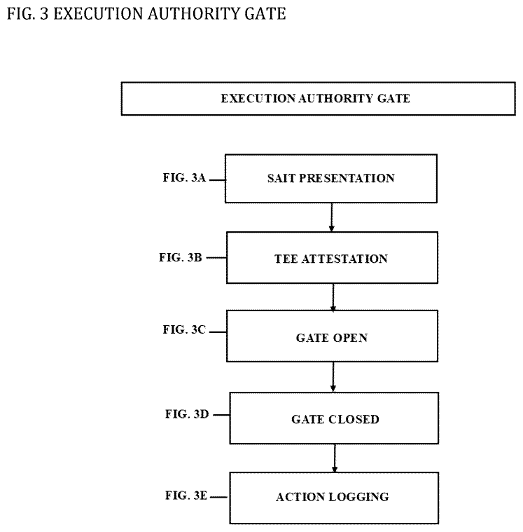

### FIG. 3 Execution Authority Gate

FIG. 3 illustrates the enforcement of execution authority.

FIG. 3A SAIT PRESENTATION shows an agent presenting its SAIT before any initialization, planning, or actuation request. The presentation occurs automatically at the start of every action cycle. The hardware security module immediately begins verification of the token.
FIG. 3B TEE ATTESTATION shows the hardware verification of the SAIT's validity, signature, and revocation status inside the hardware security module. The verification is performed entirely in isolated hardware. This step guarantees that only authorized agents can proceed.
FIG. 3C GATE OPEN shows the release of execution authority when the SAIT is valid and current. The gate opens only after successful attestation. The agent is then allowed to execute its planned actions.
FIG. 3D GATE CLOSED shows the deterministic blocking of all agent actions when the SAIT is invalid, expired, or revoked. The gate remains closed until a valid SAIT is presented. This prevents any unauthorized or compromised agent from operating.
FIG. 3E ACTION LOGGING shows the immutable recording of every permitted action and every blocked attempt. The log is written directly into the provenance ledger. This creates a complete audit trail for every decision the agent makes.

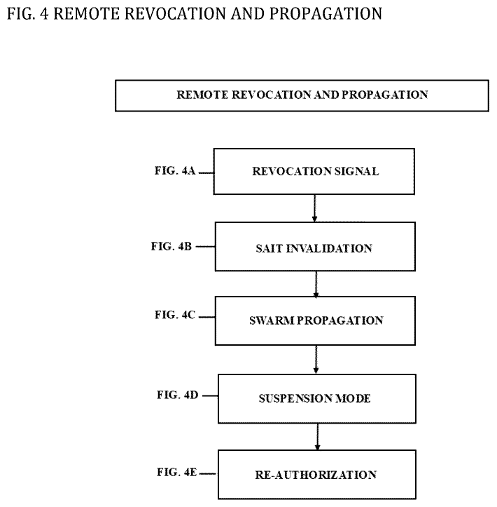

### FIG. 4 Remote Revocation and Propagation

FIG. 4 illustrates remote control and swarm-wide enforcement.

FIG. 4A REVOCATION SIGNAL shows the creation of a cryptographically signed revocation command by an authorized party. The command is sent securely to the target device. The hardware security module processes the command immediately upon receipt.
FIG. 4B SAIT INVALIDATION shows the immediate invalidation of the SAIT inside the hardware security module, rendering the agent inoperable. The invalidation occurs at the hardware level. No software on the device can override this action.
FIG. 4C SWARM PROPAGATION shows the secure, authenticated broadcast of the revocation signal to all peer agents in the same swarm. Each receiving agent validates the signal before acting. The propagation ensures coordinated shutdown across the entire group.
FIG. 4D SUSPENSION MODE shows temporary suspension of the SAIT without permanent revocation. The agent is paused but can be restored later. This mode is useful during investigations or maintenance.
FIG. 4E RE-AUTHORIZATION shows the issuance of a new SAIT after authorized remediation and re-validation. The new token replaces the suspended or revoked one. The process restores full execution authority only after compliance is confirmed.

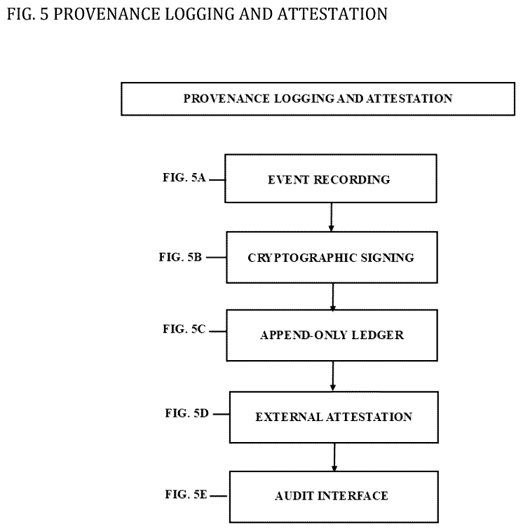

### FIG. 5 Provenance Logging and Attestation

FIG. 5 illustrates the provenance and audit capabilities of the system.

FIG. 5A EVENT RECORDING shows the recording of every lifecycle event into the provenance ledger. The ledger captures creation, actions, revocations, and updates. Every entry is timestamped and cryptographically signed.
FIG. 5B CRYPTOGRAPHIC SIGNING shows the signing of each record inside the hardware security module using the device's hardware root key. The signing occurs before any data leaves the secure enclave. This guarantees the integrity of every logged event.
FIG. 5C APPEND-ONLY LEDGER shows storage in a tamper-resistant, append-only ledger that cannot be altered or deleted. The ledger grows chronologically with each new event. This structure provides regulators with a permanent, verifiable history.
FIG. 5D EXTERNAL ATTESTATION shows the generation of cryptographically verifiable proofs for regulators, insurers, and third-party verifiers. The proofs are created on demand without exposing raw data. This allows independent verification of the agent's compliance status.
FIG. 5E AUDIT INTERFACE shows the secure, read-only interface that allows authorized parties to retrieve and independently verify the full provenance chain. Access is granted only after strong authentication. The interface supports both real-time queries and full historical audits.

1. A sovereign identity and execution control system for autonomous agents, comprising:
a hardware security module configured to generate and store a cryptographically signed sovereign identity token permanently bound to a physical device;
an execution control mechanism that permits agent operations only upon successful verification of said sovereign identity token;
a cryptographic revocation mechanism enabling remote invalidation of said token; and
a tamper-resistant logging system recording all identity lifecycle events,
wherein invalidation of said token renders the agent inoperable regardless of software state or configuration.

2. A computer-implemented method for controlling execution of autonomous agents, comprising:
generating a cryptographically unique identity token bound to physical hardware at device initialization;
storing immutable agent provenance data within said identity token including at least one of model lineage, training dataset fingerprints, ownership chain, or compliance state;
requiring hardware-verified presentation of said identity token before permitting agent initialization or actuation;
providing cryptographic attestation of agent identity and state to external verifiers; and
enabling remote cryptographic invalidation of said identity token that persists across device reboots and software reinstallation.

3. A non-transitory computer-readable medium storing instructions that, when executed by a hardware security module, cause the system to perform the method of claim 2.

4. The system of claim 1, wherein the sovereign identity token includes a genesis block containing model lineage and training data hashes.

5. The system of claim 1, wherein the sovereign identity token is irreversibly bound to the device's hardware at manufacture or first boot.

6. The system of claim 1, further comprising remote revocation of the sovereign identity token that instantly renders the agent inoperable.

7. The system of claim 1, further comprising a swarm propagation protocol for secure broadcast of revocation signals to peer agents.

8. The method of claim 2, wherein the genesis block is created inside the hardware security module.

9. The system of claim 1, further comprising cryptographic attestation generated inside the hardware security module for external verifiers.

10. The system of claim 1, wherein the execution control mechanism is non-bypassable even if the host operating system is compromised.

11. The method of claim 2, further comprising suspension of the sovereign identity token without permanent revocation.

12. The system of claim 1, further comprising an immutable agent provenance chain recording every lifecycle event.

13. The system of claim 1, wherein the sovereign identity token carries the current compliance state of the agent.

14. The method of claim 2, further comprising re-issuance of a new sovereign identity token after authorized remediation.

15. The system of claim 1, further comprising dynamic policy injection into the agent's decision loop.

16. The method of claim 2, wherein revocation signals are cryptographically signed inside the hardware security module.

17. The system of claim 1, wherein the provenance ledger is append-only and tamper-resistant.

18. The system of claim 1, further comprising owner-chain tracking within the sovereign identity token.

19. The method of claim 2, further comprising generation of verifiable attestations for regulators and insurers.

20. The system of claim 1, wherein the execution control mechanism blocks all actuation commands lacking a valid sovereign identity token.

21. The system of claim 1, further comprising swarm-wide propagation of compliance violations.

22. The method of claim 2, further comprising immutable logging of every permitted and blocked action.

23. The system of claim 1, wherein the sovereign identity token serves as both the birth certificate and the ongoing execution authority.

24. The method of claim 2, wherein the hardware-rooted binding prevents cloning or spoofing of the agent.

25. The system of claim 1, wherein revocation of the sovereign identity token is effective across all instances of the agent.
